(19) United States
(12) Patent Application Publication
(10) Pub. No.: US 2022/0138645 A1
(43) Pub. Date: May 5, 2022

(54) METHOD AND SYSTEM FOR FACILITATING SYSTEMATIC ESCALATION OF AN EVENT IN AN ORGANIZATIONAL HIERARCHY

(71) Applicant: Zensar Technologies Limited, Pune (IN)

(72) Inventors: Sumant Kulkarni, Pune (IN); Mukul Tiwari, Pune (IN)

(21) Appl. No.: 17/219,069

(22) Filed: Mar. 31, 2021

(30) Foreign Application Priority Data
Nov. 5, 2020 (IN) 202021048381

(51) Int. Cl. G06Q 10/06; G06Q 10/10; G06F 40/20; G06K 9/62; G06N 20/00

(52) U.S. Cl. CPC G06Q 10/0635; G06Q 10/105; G06N 20/00; G06K 9/628; G06F 40/20

(57) ABSTRACT

Disclosed herein is method and system for facilitating systematic escalation of information related to an event in an organizational hierarchy. The system extracts organization data pertaining to plurality of events from plurality of data sources associated with an organization. Each of the plurality of events is categorized into a category of plurality of categories. For each event belonging to each category a criticality score is assigned based on the content of each event. Each category is also assigned a criticality threshold. Once, it has been determined that the event must be escalated, the system determines one or more entities involved in the event. The system then identifies first point of contact from the organizational hierarchy database to whom the event must be escalated. Post escalating to the first point of contact, the system monitors for predefined time-period, a resolve status of the event.

### TECHNICAL FIELD

The present invention relates to a field of information processing in an organization and more particularly, to identification of criticality of an information and systematic escalation of the information based on the identified criticality.

### BACKGROUND OF THE INVENTION

In an organization, there exists various departments with people at different hierarchical levels. It may happen that a person from the organization needs to escalate some critical information to a person at a higher level in the hierarchical chain. However, for the information to reach to the higher level, it has to be escalated systematically by people at lower levels or mid-levels. This creates a problem in situations where people at the lower or mid-levels due to their personal interest do not escalate the information to the higher level, or in other words conceal the information from people at higher authority. In situations where a person has made a complaint against his/her senior might not get escalated to the proper authority due to concealing of information by one or more people in the hierarchical chain and therefore prevent rightful action against the accused person. Apart from this, there can exist many situations where concealing of information proves to be hazardous for the organization or the people involved.

For resolving this issue, one solution could be to train the people and help them understand ethics and policies of the organization. However, in such type of solutions there still exists an issue with the nature or mindset of the people responsible for passing the information to the higher authority.

Therefore, it is important to device a system that facilitates systematic escalation of information in an organizational hierarchy.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In one embodiment of the present disclosure, a method for facilitating systematic escalation of information related to an event in an organizational hierarchy is disclosed. The method comprises extracting organization data from a plurality of data sources. The organization data pertains to plurality of events occurring within an organization. The method further comprises determining a context for each of the plurality of events by applying a Natural Language Processing (NLP) technique on the organization data. The method further comprises categorizing each of the plurality of events, based on the corresponding context, into a category of a plurality of categories. Each of the plurality of categories indicate nature of the one or more events of the plurality of events associated therewith. The method further comprises assigning a criticality score to each of the one or more events associated with a category based on content, of the one or more events, indicating criticality level and each of the plurality of categories is assigned a criticality threshold. The method further comprises determining whether to escalate at least one event of the one or more events associated with the category based on the criticality score assigned to the at least one event and the criticality threshold of the category associated therewith. Further, upon determining escalation of the at least one event, the method further comprises the steps of determining, identifying, monitoring and re-escalating. That is, the method comprises determining, from the at least one event to be escalated, one or more entities mentioned in the at least one event. The method comprises identifying at least one point of contact, based on the one or more entities, from an organizational hierarchy database, such that the at least one event is escalated to the identified at least one point of contact. The method further comprises monitoring, for a predefined time period, a resolve status of the at least one event supposed to be resolved by the at least one point of contact. Further, the method comprises re-escalating the at least one event to at least one another point of contact identified from the organizational hierarchy database when the at least one event is not resolved by the at least one point of contact within the predefined time period.

In one embodiment of the present disclosure, a system for facilitating systematic escalation of information related to an event in an organizational hierarchy is disclosed. The system comprises an extraction unit to extract organization data from a plurality of data sources. The organization data pertains to plurality of events occurring within an organization. The system further comprises a determination unit to determine a context for each of the plurality of events by applying a Natural Language Processing (NLP) technique on the organization data. The system further comprises a categorization unit to categorize each of the plurality of events, based on the corresponding context, into a category of a plurality of categories. Each of the plurality of categories indicate nature of the one or more events of the plurality of events associated therewith. The system further comprises a scoring unit to assign a criticality score to each of the one or more events associated with a category based on content, of the one or more events, indicating criticality level and each of the plurality of categories is assigned a criticality threshold. The system further comprises a decision making unit to determine whether to escalate at least one event of the one or more events associated with the category based on the criticality score assigned to the at least one event and the criticality threshold of the category associated therewith. Further, upon determining escalation of the at least one event, the system further comprises an execution unit configured to determine, from the at least one event to be escalated, one or more entities mentioned in the at least one event. The execution unit is further configured to identify at least one point of contact, based on the one or more entities, from an organizational hierarchy database, such that the at least one event is escalated to the identified at least one point of contact. The execution unit is further configured to monitor, for a predefined time period, a resolve status of the at least one event supposed to be resolved by the at least one point of contact and to re-escalate the at least one event to at least one another point of contact identified from the organizational hierarchy database when the at least one event is not resolved by the at least one point of contact within the predefined time period.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 shows an exemplary environment 100 of a system for facilitating systematic escalation of an event in an organizational hierarchy, in accordance with an embodiment of the present disclosure;

FIG. 2 shows a block diagram 200 illustrating a system for facilitating systematic escalation of an event in an organizational hierarchy, in accordance with an embodiment of the present disclosure;

FIGS. 3A and 3B shows a method 300 for facilitating systematic escalation of an event in an organizational hierarchy in accordance with an embodiment of the present disclosure; and

FIG. 4 shows a block diagram of an exemplary computer system 400 for implementing the embodiments consistent with the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Disclosed herein is a method and a system for facilitating systematic escalation of information related to an event in an organizational hierarchy. Generally, the people in any organization communicates on various professional and personal topics. To keep the environment of the organization healthy, it is utmost important to have a proper transparency and timely update of critical/sensitive information to authorized person or authority. For example, the critical information may be a complaint which might be a minor or a serious offence. In another example, the critical information may even be an appreciation email received from any client for a particular member in a team, and the team lead might not forward it to higher authorities like HR team, which in turn might affect the team member in his/her appraisal or promotion process. In both the cases, such kind of human behaviour may impact the overall growth of the organization. However, the technical challenge while overcome such issues is to understand overall hierarchy of the organization, and at same time to manage the data flow across the organization in real-time for taking timely actions.

Considering the example of the complaint, the system disclosed in the present disclosure may first understands the context or seriousness of the communication happening between people within the organization, and then automatically takes a call to whom the communication should be escalated. On one hand, the system continuously monitors the different modes of the communication and its content. On other hand, the system also directs the flow of the communication towards the appropriate person/authority without any manual intervention. This kind of process not only gives a relief to the person (victim or sufferer) whose complaint or communication directly reaches to the concerned persons/authorities, but also puts an obligation on the concerned persons/authorities to take timely actions. The detailed working of the system is explained in the upcoming paragraphs of the specification with help of drawings.

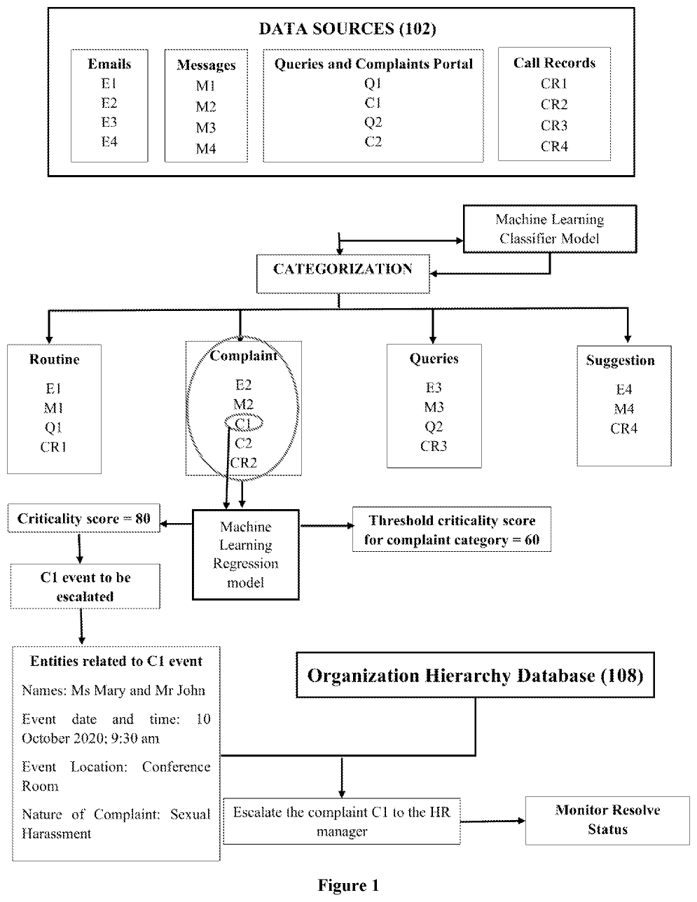

FIG. 1 shows an exemplary environment 100 of a system for facilitating systematic escalation of an event in an organizational hierarchy in accordance with an embodiment of the present disclosure. It must be understood to a person skilled in art that the present invention may also be implemented in various environments, other than as shown in FIG. 1.

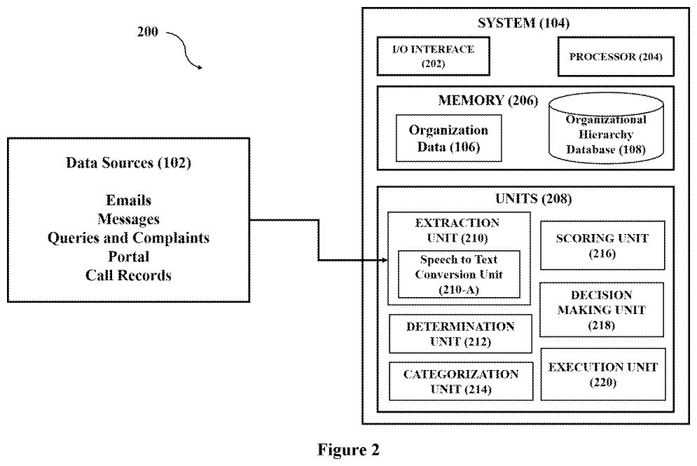

The detailed explanation of the exemplary environment 100 is explained in conjunction with FIG. 2 that shows a block diagram of the system 104 for facilitating systematic escalation of an event in an organizational hierarchy in accordance with an embodiment of the present disclosure. According to an embodiment of present disclosure, the system 104 may comprise input/output interface 202, a processor 204, a memory 206, and units 208. The I/O interface 202 may include a variety of software and hardware interfaces, for example, a web interface, a graphical user interface, input device, output device and the like. The I/O interface 202 may allow the system 104 to interact with the user directly or through other devices. The memory 206 is communicatively coupled to the processor 204. Further, the memory 206 stores organization data 106 and the organization hierarchy database 108, which are explained in the upcoming paragraphs of the specification. Further, the units 208 comprises an extraction unit 210, a determining unit 212, a categorization unit 214, a scoring unit 216, a decision making unit 218, and an execution unit 220. According to embodiments of present disclosure, these units 212-220 may comprise a dedicated hardware components like processor, microprocessor, microcontrollers, circuitries, application-specific integrated circuits for executing the various operations of the system 104.

Now referring back to FIG. 1, the environment 100 comprises a plurality of data sources 102 pertaining to an organization. The data sources 102 may comprise of, but not limited to, emails E1-E4, messages M1-M4, call records CR1-CR4 and a queries and complaints portal comprising data Q1-Q2 and C1-C2. Since in the organization, the data flows from various sources, the first step is to organize the data in a systematic manner.

For this, an extraction unit 210 of the system 104 extracts the organization data 106 from the plurality of data sources 102 pertaining to a plurality of events occurring within the organization. The organization data 106 extracted is then stored in the memory 206 of the system 104. Referring to the FIG. 1, it can be observed that the emails E1-E4, messages M1-M4, data from queries and complaints portal Q1-Q2 and C1-C2 and call records CR1-CR4 correspond to the plurality of events occurring within the organization. Here, the events may be understood as like someone writing an email to his/her colleague, or some team member chatting with his colleagues on a chatting platform or some person talking to another person over the phone or audio/video call.

Post extracting the organization data 106, the next step is to understand the meaning or context of the extracted data. For this, the extraction unit 210 first coverts the call records CR1-CR4 into text form using a speech to text conversion unit 210-A to normalize all the data in textual format, and then passes the textual data to further hardware units of the system 104 for processing.

That is, a determination unit 212 of the system 104 now applies a natural language processing (NLP) technique on the organization data 106 (in the textual format) to determine the context of the plurality of events. Determining of the context further helps the system 104 to understand the nature of the communication happening within the organization. For example, if the determining unit 212 determines few rude words between two people over a chat (event), it understands that something is not well, and such communication now requires a closer look. However, in another example, while analyzing the textual data of the call record (event) of two persons, the determining unit 212 may determine that though there few unpleasant words used during the communication, but the intent was not to hurt or disrespect anyone, and therefore the system 104 considers this as a casual talk.

On basis of above understanding made by the determining unit 212, in next step, a categorization unit 214 of the system 104, categorizes each of the plurality of events into a category such as Routine, Complaint, Queries and Suggestion. It must be understood that these categories are merely an example, and there may be some additional categories generated by the categorization unit 214. For instance, as shown in environment 100, events E1, M1, Q1 and CR1 are categorized into “Routine” category, while events E2, M2, C1, C2 and CR2 are categorized into “Complaint” category. Similarly, events E3, M3, Q2 and CR3 are categorized into “Query” category and events E4, M4 and CR4 are categorized into “Suggestion” category.

According to embodiments of the present disclosure, to categorize the organization data 106 into a category of the plurality of categories, the categorization unit 214 implements a Machine Learning Classifier Model. The Machine Learning Classifier Model is trained by initially manually categorizing the organization data 106 into a category. Thereafter, the manually categorized organization data 106 is converted into numerical representation by implementing a Term Frequency/Inverse Document Frequency (TF/IDF) Vectorization or Bag of Words. This numerical data therefore acts as a training set for the Machine Learning Classifier Model to categorize future organization data 106 extracted from the plurality of data sources 102 into a category of the plurality of categories. According to an embodiment, the Machine Learning Classifier Model may comprise at least one of a Naïve Bayes Classifier, a Support Vector Machines and a Neural Network. The categorization of the events further helps the system 104 to understand the nature of events more clearly which are occurring in the organization. However, categorization alone will not suffice the system 104 to take a call on whether to escalate the events to the concerned person or authority, which is the objective of the present disclosure.

For this, the system 104 comprises a scoring unit 216 that assigns score to each of the one or more events in a category by implementing a Machine Learning Regression Model.

According to the embodiments of present disclosure, the Machine Learning Regression Model is trained by manually scoring each event of the one or more events categorized in a category based on the content of their content. The manually scored each event of the one or more events is converted into numerical representation by implementing a Term Frequency/Inverse Document Frequency (TF/IDF) Vectorization or Bag of Words. The numerical representation of the already scored events thus serves as a training set for the Machine Learning Regression Model to assign a criticality score to the future events being categorized in a category of the plurality of categories. It must be understood that the above discussion that the categorization and scoring saves a significant amount computing time and effort for the system 104 which can neglect minor events (like routine emails, regular calls and the like) and focus more on critical events.

For instance, as shown in the environment 100, the event C1 in category “complaint” is assigned a criticality score of 80. It may be noted by a skilled person that the criticality score can be assigned in various forms such as a grade, a score out of 10 or 100, a percentage and like. Along with the scoring of the events, the scoring unit 216 may also assign a criticality threshold score to each category, which may act as a fulcrum to test the criticality of the events in that category and also enables the system 104 for taking further actions. For instance, as shown in environment 100, the category “Complaint” is assigned a criticality threshold of 60, whereas the criticality score assigned to the event C1 is 80 i.e., more than the threshold limit.

In other words, the comparison between the criticality threshold score of a category and the criticality score of the one or more events categorized in that category helps the decision-making unit 218 in determining whether to escalate the one or more events or not. Further, if the decision-making unit 218 determines that the one or more events has to be escalated, the assigned criticality score also helps the decision-making unit 218 to decide the level in the organizational hierarchy up to which the one or more events should be escalated. For instance, as shown in environment 100, the criticality score of event C1 is 80 and the criticality threshold of the “Complaint” category is 60. Since, the criticality score of event C1 exceeds the threshold of the “Complaint” category, the decision-making unit 218 decides to escalate the event C1.

Now, when the decision-making unit 218 has decided that the event C1 must be escalated, the execution unit 220 determines one or more entities mentioned in the event C1. For instance, as shown in the environment 100, the one or more entities identified by the execution unit 220 comprise names of the persons involved in the event C1 as John and Mary, date and time of the event C1 as 10 Oct. 2020 and 9:30 am, location of the event C1 as conference room and it also identifies the nature of event C1 as a sexual harassment complaint. This nature helps the execution unit 220 in understanding to whom the event C1 must be escalated to.

After identifying the one or more entities associated with the event, the execution unit 220 accesses an organizational hierarchy database 108 stored in the memory 206 of the system 104. In one embodiments, the organizational hierarchy database 108 may comprise a plurality of hierarchical structures for different departments in the organization and names and contact information of one or more people at each level of a hierarchical structure of the plurality of hierarchical structures. From the organizational hierarchy database 108, the execution unit 220 identifies a first point of contact to whom the event must be escalated to. For instance, as shown in the environment 100, the execution unit 220 identifies the first point of contact to whom the event C1 has to be escalated to as the HR manager.

According to embodiments of present disclosure, the execution unit 220 also determines whether to escalate the event in anonymous mode or not. The determination to anonymize the person raising the event, may depend upon another criticality threshold assigned to a category of the plurality of categories which determines whether to anonymize the person raising the event.

Post-identifying, the execution unit 220 escalates the event to the identified first point of contact. For instance, as shown in environment 100, the event C1 is escalated to the HR manager who acts as the first point of contact. Once, the event C1 has been escalated to the HR manager first point of contact, the execution unit 220, monitors for a predefined time-period the resolve status of the event C1. Accordingly, the execution unit 220, monitors whether in the predefined time-period, the first point of contact, that is, the HR manager in environment 100 has taken any action on the event C1 or not. If within the predefined time-period, the first point of contact, the HR manager, has not taken any action, the event C1 is escalated to a second or another point of contact identified from the organizational hierarchy database 108.

According to embodiments of present disclosure, the execution unit 220 is also configured to monitor the status of the escalated event C1 by activating a plurality of triggers/trackers such as a “deletion trigger”, “unintended trigger” and “escalation tracker”. The deletion trigger gets activated when it is determined that the first point of contact to whom the event C1 was escalated to has deleted the event. If the event C1 has been deleted by the first point of contact, the HR manager, the execution unit 220 re-escalates the event C1 to a second point of contact identified from the organizational hierarchy database 108. The execution unit 220 may also activate the unintended trigger when it is determined that the event C1 has been escalated or re-escalated to an unintended point of contact, for example, the manager of the accounts department who has nothing to do with the event C1 which is related sexual harassment. In such a scenario, the execution unit 220 may send an intimation to the unintended point of contact notifying that the event C1 was escalated to him/her unintentionally and that no action is expected from him/her for the event C1. The execution unit 220 may then re-escalate the event C1 to a rightful point of contact identified from the organizational hierarchy database 108. Further, the execution unit 220 may also activate the resolution tracker when it is determined that the event C1 has been resolved by the first or the second point of contact to whom the event was escalated or re-escalated to. The execution unit 220 may then also provide the person associated with the event an intimation related to the resolution of the event C1.

In this manner, the system 104 with the interaction of its various components facilitates a systematic escalation of information related to an event in an organizational hierarchy by removing any biasness that may arise due to personal interests of a person.

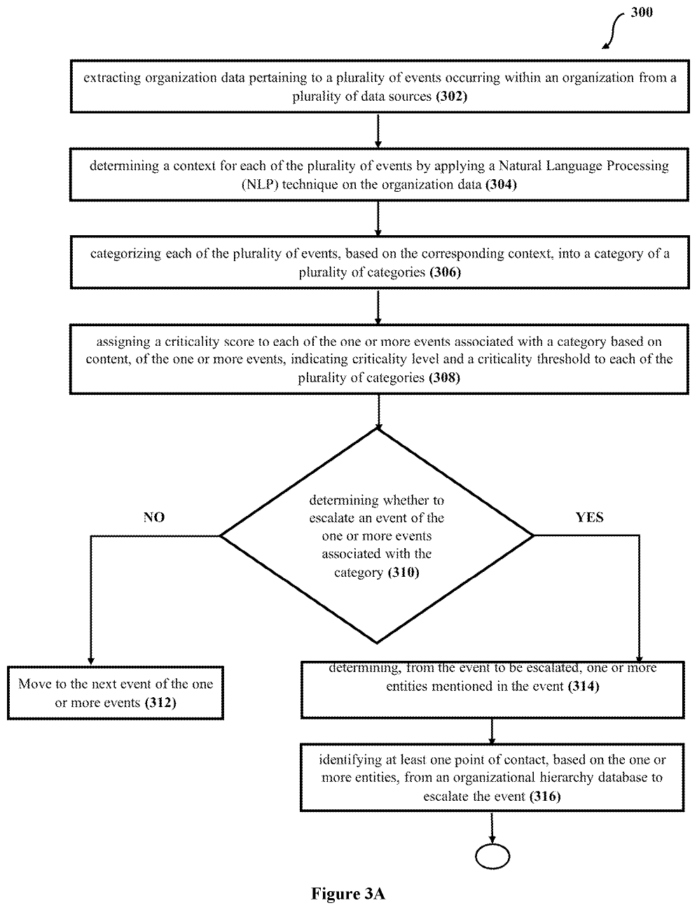

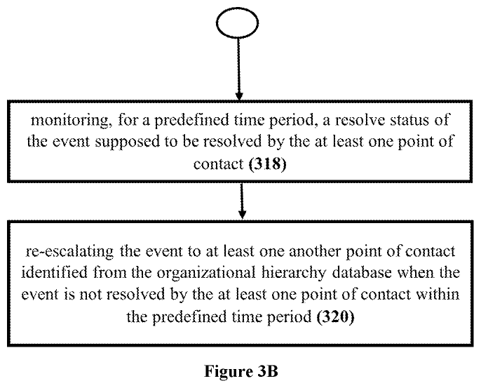

FIGS. 3A and 3B depict a method 300 for facilitating systematic escalation of an event in an organizational hierarchy in accordance with an embodiment of the present disclosure.

As illustrated in FIGS. 3A and 3B, the method 300 includes one or more blocks illustrating a method for facilitating systematic escalation of an event in an organizational hierarchy. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein.

At block 302, the method 300 may include extracting organization data 106 pertaining to a plurality of events occurring within an organization from a plurality of data sources 102 such as e-mails, messages, call records, and queries and complaints portal.

At block 304, the method 300 may include determining a context for each of the plurality of events by applying a Natural Language Processing (NLP) technique on the organization data 106.

At block 306, the method 300 may include categorizing each of the plurality of events, based on the corresponding context into a category of a plurality of categories. The plurality of categories may comprise of Routine, Complaint, Queries and Suggestion.

At block 308, the method 300 may include assigning a criticality score to each of the one or more events associated with a category based on content, of the one or more events, indicating criticality level and a criticality threshold to each of the plurality of categories.

At block 310, the method 300 may include determining whether to escalate at least one event of the one or more events associated with the category based on the criticality score assigned to the at least one event and the criticality threshold of the category associated therewith. If the result of the determination is “NO”, the method 300 may proceed to block 312. However, if the result of the determination is “YES”, the method 300 may proceed to block 314 followed by blocks 316-320.

At block 312, the method 300 may include moving to a next event of the one or more events in a category to determine whether to escalate the next event.

At block 314, the method 300 may include determining, from the event to be escalated, one or more entities mentioned in the event. The one or more entities comprises at least one of names of persons involved in the at least one event, location, date and time of the at least one event and a plurality of custom entities pertaining to the organization.

At block 316, the method 300 may include identifying at least one point of contact, based on the one or more entities, from an organizational hierarchy database, to escalate the at least one event.

At block 318, the method 300 may include monitoring, for a predefined time period, a resolve status of the at least one event supposed to be resolved by the at least one point of contact.

At block 320, the method 300 may include re-escalating the at least one event to at least one another point of contact identified from the organizational hierarchy database when the at least one event is not resolved by the at least one point of contact within the predefined time period.

Computer System

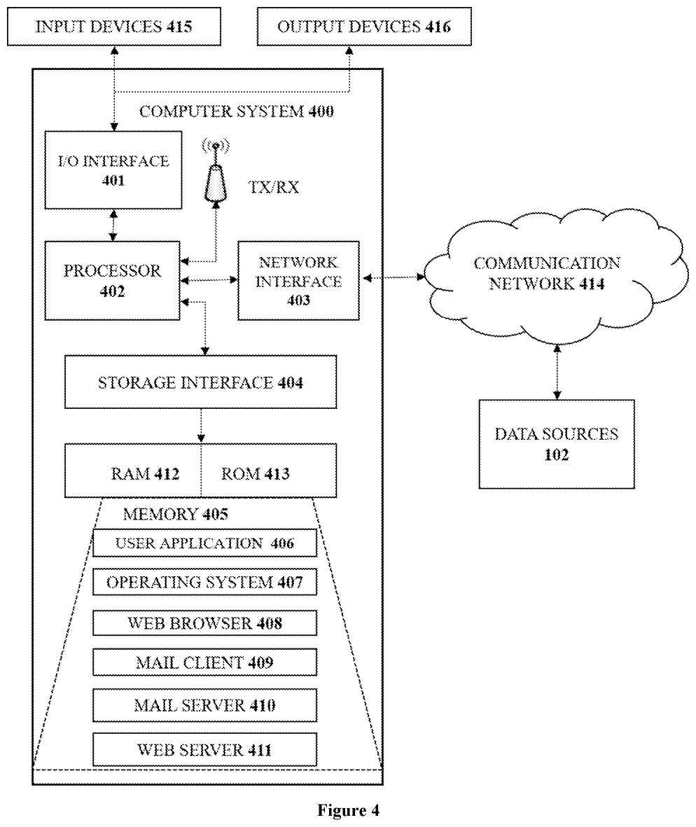

FIG. 4 illustrates a block diagram of an exemplary computer system 400 for implementing embodiments consistent with the present disclosure. In an embodiment, the computer system 400 may be a peripheral device, which is used for facilitating systematic escalation of information related to an event in an organizational hierarchy. The computer system 400 may include a central processing unit (“CPU” or “processor”) 402. The processor 402 may comprise at least one data processor for executing program components for executing user or system-generated business processes. The processor 402 may include specialized processing units such as integrated system (bus) controllers, memory management control units, floating point units, graphics processing units, digital signal processing units, etc.

The processor 402 may be disposed in communication with one or more input/output (I/O) devices via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface, the computer system 400 may communicate with one or more I/O devices.

In some embodiments, the processor 402 may be disposed in communication with a communication network 414 via a network interface 403. The network interface 403 may communicate with the communication network 414. The communication unit may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 414 can be implemented as one of the several types of networks, such as intranet or Local Area Network (LAN) and such within the organization. The communication network 414 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 414 may include a variety of network devices, including routers, bridges, servers, computing devices, storage devices, etc.

In some embodiments, the processor 402 may be disposed in communication with a memory 405 (e.g., RAM 412, ROM 413, etc. as shown in FIG. 4) via a storage interface 404. The storage interface 404 may connect to the memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application, an operating system, a web browser, mail client, mail server, web server and the like. In some embodiments, computer system may store user/application data, such as the data, variables, records, etc. as described in this invention. Such databases may be implemented as fault-tolerant, relational, scalable, secure databases such as Oracle® or Sybase®.

The operating system may facilitate resource management and operation of the computer system. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference | |
|---|---|
| Numeral | Description |
| 100 | Exemplary enviroment of a system for facilitating |
| | systematic escalation of information related to an |
| | event in an organizational hierachy |
| 102 | Data Sources |
| 104 | System |
| 106 | Organization Data |
| 108 | Organizational Hierarchy Database |
| 200 | Block diagram of the system 104 |
| 202 | Input/output interface |
| 204 | Processor |
| 206 | Memory |
| 208 | Units |
| 210 | Extraction Unit |
| 210-A | Speech to Text Conversion Unit |
| 212 | Determination Unit |
| 214 | Categorization Unit |
| 216 | Scoring Unit |
| 218 | Decision-Making Unit |
| 220 | Execution Unit |

We claim:

1. A method for facilitating systematic escalation of information related to an event in an organizational hierarchy, the method comprising:
extracting organization data from a plurality of data sources, wherein the organization data pertains to plurality of events occurring within an organization;
determining a context for each of the plurality of events by applying a Natural Language Processing (NLP) technique on the organization data;
categorizing each of the plurality of events, based on the corresponding context, into a category of a plurality of categories, wherein each of the plurality of categories indicate nature of the one or more events of the plurality of events associated therewith;
assigning a criticality score to each of the one or more events associated with a category based on content, of the one or more events, indicating criticality level, wherein each of the plurality of categories is assigned a criticality threshold;
determining whether to escalate at least one event of the one or more events associated with the category based on the criticality score assigned to the at least one event and the criticality threshold of the category associated therewith; and
upon determining escalation of the at least one event, the method further comprising:
determining, from the at least one event to be escalated, one or more entities mentioned in the at least one event;
identifying at least one point of contact, based on the one or more entities, from an organizational hierarchy database, wherein the at least one event is escalated to the identified at least one point of contact;
monitoring, for a predefined time period, a resolve status of the at least one event supposed to be resolved by the at least one point of contact; and
re-escalating the at least one event to at least one another point of contact identified from the organizational hierarchy database when the at least one event is not resolved by the at least one point of contact within the predefined time period.

2. The method as claimed in claim 1, further comprising activating at least one of:
a deletion trigger when the at least one point of contact to whom the at least one event is escalated, deletes the at least one event without providing a response;
an unintended trigger when the at least one event is escalated or re-escalated to at least one unintended point of contact; and
a resolution tracker when a response is provided by the at least one point of contact to whom the at least one event is escalated or by the at least one another point of contact to whom the at least one event is re-escalated.

3. The method as claimed in claim 1, wherein:
the plurality of data sources comprises at least one of e-mails, messages, call records, and queries and complaints portal;
the one or more categories comprises at least one of routine, complaint, query and suggestion,
and wherein while categorizing each of the plurality of events into the at least one of the plurality of categories, a machine-learning model comprising at least one of Naïve Bayes Classifier, Support Vector Machines and Neural Network is trained; and
and wherein while assigning the criticality score to the each of the one or more events, a machine-learning regression model is trained.

4. The method as claimed in claim 1, wherein the one or more entities comprises at least one of names of persons involved in the at least one event, location, date and time of the at least one event and a plurality of custom entities pertaining to the organization.

5. The method as claimed in claim 1, wherein the organizational hierarchy database comprises:
a plurality of hierarchical structures for different departments in the organization; and
names and contact information of one or more people at each level of a hierarchical structure of the plurality of hierarchical structures.

6. A system for facilitating systematic escalation of information related to an event in an organizational hierarchy, the system comprising:
an extraction unit to extract organization data from a plurality of data sources, wherein the organization data pertains to plurality of events occurring within an organization;
a determination unit to determine a context for each of the plurality of events by applying a Natural Language Processing (NLP) technique on the organization data;
a categorization unit to categorize each of the plurality of events, based on the corresponding context, into a category of a plurality of categories, wherein each of the plurality of categories indicate nature of the one or more events of the plurality of events associated therewith;
a scoring unit to assign a criticality score to each of the one or more events associated with a category based on content, of the one or more events, indicating criticality level, wherein each of the plurality of categories is assigned a criticality threshold;
a decision-making unit to determine whether to escalate at least one event of the one or more events associated with the category based on the criticality score assigned to the at least one event and the criticality threshold of the category associated therewith; and
when it is determined to escalate the at least one event, an execution unit configured to:
determine, from the at least one event to be escalated, one or more entities mentioned in the at least one event;
identify at least one point of contact, based on the one or more entities, from an organizational hierarchy database, wherein the at least one event is escalated to the identified at least one point of contact;
monitor, for a predefined time period, a resolve status of the at least one event supposed to be resolved by the at least one point of contact; and
re-escalate the at least one event to at least one another point of contact identified from the organizational hierarchy database when the at least one event is not resolved by the at least one point of contact within the predefined time period.

7. The system as claimed in claim 6, is further configured to activate at least one of:
a deletion trigger when the at least one point of contact to whom the at least one event is escalated, deletes the at least one event without providing a response;
an unintended trigger when the at least one event is escalated or re-escalated to at least one unintended point of contact; and
a resolution tracker when a response is provided by the at least one point of contact to whom the at least one event is escalated or by the at least one another point of contact to whom the at least one event is re-escalated.

8. The system as claimed in claim 6, wherein:
the plurality of data sources comprises at least one of e-mails, messages, call records, and queries and complaints portal;
the one or more categories comprises at least one of routine, complaint, query and suggestion,
and wherein while categorizing each of the plurality of events into the at least one of the plurality of categories, a machine-learning model comprising at least one of Naïve Bayes Classifier, Support Vector Machines and Neural Network is trained; and
and wherein while assigning the criticality score to the each of the one or more events, a machine-learning regression model is trained.

9. The system as claimed in claim 6, wherein the one or more entities comprises at least one of names of persons involved in the at least one event, location, date and time of the at least one event and a plurality of custom entities pertaining to the organization.

10. The system as claimed in claim 6, wherein the organizational hierarchy database comprises:
a plurality of hierarchical structures for different departments in the organization; and
names and contact information of one or more people at each level of a hierarchical structure of the plurality of hierarchical structures.
